(19) United States
(12) Patent Application Publication
(10) Pub. No.: US 2009/0090245 A1
(43) Pub. Date: Apr. 9, 2009

(54) FILTER ASSEMBLY

(75) Inventor: Jason R. Olszewski, Eden Prairie, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: Donaldson Company, Inc., Minneapolis, MN (US)

(21) Appl. No.: 12/246,241

(22) Filed: Oct. 6, 2008

Related U.S. Application Data
(60) Provisional application No. 60/977,640, filed on Oct. 4, 2007.

(51) Int. Cl. B01D 53/02

(52) U.S. Cl. 96/154; 96/108

(57) ABSTRACT

The present invention is directed to a seal configured to be placed over an opening in an electronic enclosure. In certain embodiments the seal covers a depression in the surface of the electronic enclosure, wherein the seal is configured to be adhesively secured along its perimeter to the surface of the electronic enclosure. An absorbent-containing filter element integral with the seal is configured to be placed within the depression in the surface of the electronic enclosure. A channel is configured to be in fluid communication through the seal, said channel further in fluid communication with the adsorbent-containing filter element.

### PRIORITY

This application claims priority to U.S. Provisional Application Ser. No. 60/977,640, filed Oct. 4, 2007, the content of which is herein incorporated by reference.

### TECHNOLOGICAL FIELD

The technology described herein relates generally to filters. More particularly, the technology described herein relates to filter assemblies configured to be mounted over the breather hole of an enclosure.

### BACKGROUND

Filters are useful in a variety of contexts. For example, filters are often used in electrical or optical equipment. An air pressure differential between the interior and exterior of a housing containing the equipment can be produced as the electrical or optical equipment heats and cools. Often the housing includes a vent to allow air flow that equalizes the pressure. A filter is typically provided over the vent to reduce the flow of contaminants into and/or out of the housing.

Computer disk drives, and in particular, hard disk drives, are one example of a device that uses filters in this manner. Disk drives are sensitive to moisture, chemical contamination, and particulate contamination, particularly, as the drive heads become smaller and aerial densities increase. Chemical contaminants, such as hydrocarbons and acid gases, can condense onto a disk and degrade the head/disk interface and/or corrode the heads. Particulate contaminants can lead to friction and can cause read/write errors and head crashes.

A filter placed over a vent in a disk drive typically includes filter material that filters particles and contaminants from the air. To increase the lifetime of filter material, particularly adsorbent filter material, a long and narrow flow path is often provided within the walls of the housing or in a cover disposed against the housing so that air flows along the path, through the filter, and into the interior of the housing. This path is often referred to as a “diffusion channel”. The presence of a diffusion channel can reduce the amount of chemical contaminants and moisture reaching the adsorbent material of the filter and/or the inside of the disk drive.

Although existing breather filters are well suited to many applications, a need remains for improvements to breather filters that allow for greater ease in installation, that reduce installation labor, and that provide superior filtration and adsorption properties.

### SUMMARY

Generally, the technology disclosed herein relates to an assembly comprising a filter coupled to a seal, the assembly having a diffusion channel or breather hole formed in at least one layer of the assembly. The filter and seal assembly can be installed at the opening to any enclosure where the filtration of incoming air is desired, such as a disk drive enclosure. One embodiment comprises a filter assembly having one or more adhesive laminates defining a channel, and filter media disposed in fluid communication with the channel.

Certain aspects of the invention are directed to a filter comprising a seal configured to be placed over an opening in an electronic enclosure, the opening located within a depression in the surface of the electronic enclosure. The seal is configured to be adhesively secured along its perimeter to the surface of the electronic enclosure. A filter element is integral to the seal, the filter element configured to be placed within the depression in the surface of the electronic enclosure. Generally a channel provides fluid communication through the seal, the channel further providing fluid communication with the adsorbent-containing filter element.

In another aspect, the invention is directed to a filter for application over a breather hole in an electronic enclosure the, filter comprising a seal configured to be placed over a breather opening in the electronic enclosure. The opening is located within a depression in the surface of the electronic enclosure. The seal comprises an adhesive border portion configured to be secured the electronic enclosure, a substantially air-impermeable layer, and diffusion channel in fluid communication through the air-impermeable layer. The filter also includes an absorbent-containing filter element, the filter element configured to be placed at least partially within the depression in the surface of the electronic enclosure. Air is allowed to pass through the diffusion channel, through the adsorbent-containing filter element, and into the electronic enclosure.

In yet another aspect, the invention is directed to a filter for application over a breather hole in an electronic enclosure, the filter comprising a seal configured to be placed over a breather opening in an electronic enclosure, said opening located within a depression in the surface of the electronic enclosure. The seal comprises an air-impermeable layer, a diffusion channel travelling through the seal, an adsorbent within a filter element in communication with the diffusion channel, and filter media in communication with the adsorbent and diffusion channel.

The filter assembly is configured and arranged for flow of a fluid along the channel and into the filter media. This filter assembly can be used in a device as a filter mounted on a vent on a housing of the device. The configuration of the assembly may allow simplified installation to a hard disk drive (HDD), for example, where the assembly may be configured to be received by the HDD and the HDD may be configured to receive the assembly. The assembly may be configured to be received by the exterior of the housing of the HDD.

The above summary is not intended to describe each disclosed embodiment or every implementation of the technology disclosed here. The Figures and the detailed description which follow more particularly exemplify these embodiments.

The above summary of the present invention is not intended to describe each discussed embodiment of the present invention. This is the purpose of the figures and the detailed description that follows.

### BRIEF DESCRIPTION OF THE DRAWINGS

The invention may be more completely understood in connection with the following drawings, in which:

FIG. 1a is a cross sectional view of one embodiment of the technology disclosed herein, with a filter assembly prior to being installed in an electronic enclosure.

FIG. 1b is a cross sectional view of one embodiment of the technology disclosed herein, with a filter assembly after being installed in an electronic enclosure.

FIG. 2 is a top view of the embodiment depicted in FIG. 1

FIG. 3 is a bottom view of the embodiment depicted in FIG. 1

FIG. 4 is a perspective view of one embodiment of the technology disclosed herein.

FIG. 5 is a cross sectional view of one embodiment of the technology disclosed herein.

FIG. 6 is a cross sectional view of one embodiment of the technology disclosed herein.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

Technology disclosed herein generally is directed to an assembly comprising a filter coupled to a seal, the assembly having a diffusion channel or breather hole formed in at least one layer of the assembly. The filter and seal assembly can be installed at the opening to any enclosure where the filtration of incoming air is desired, such as a disk drive enclosure. In an example embodiment, a filter comprising a seal configured to be placed over an opening in an electronic enclosure, the opening located within a depression in the surface of the electronic enclosure. The seal is configured to be secured along its perimeter to the surface of the electronic enclosure. A filter element is integral to the seal (formed so as to be a single unit along with the seal), the filter element configured to be placed within the depression in the surface of the electronic enclosure. Generally a channel provides fluid communication through the seal, the channel further providing fluid communication with the adsorbent-containing filter element.

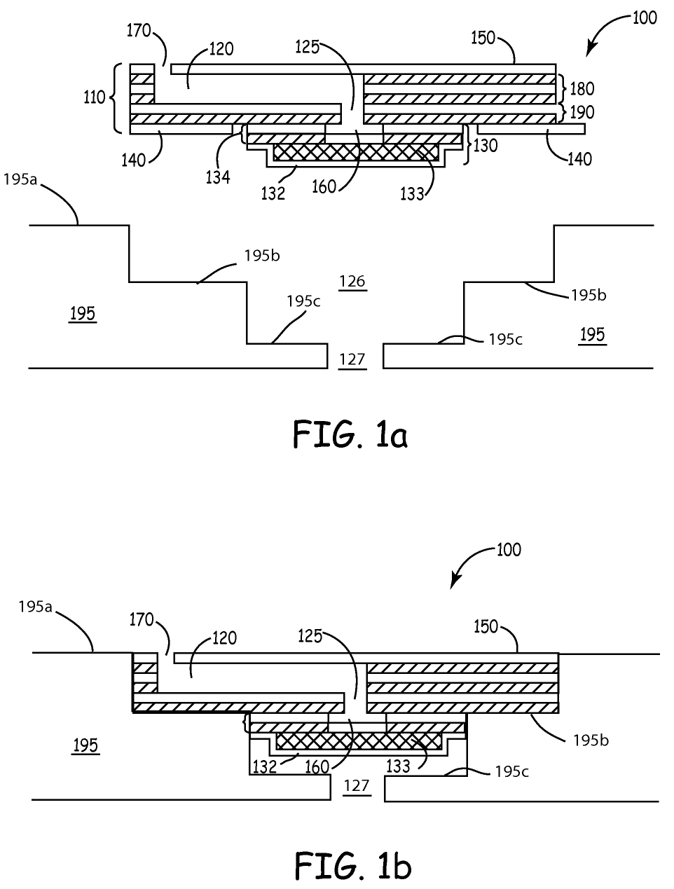

Referring first to FIGS. 1a and 1b, the assembly 100 of the invention, in a first implementation, broadly comprises a seal 110 defining a diffusion channel 120, and an adsorbent breather filter 130. In FIG. 1a the assembly 100 is shown before installation on the wall of an electronic enclosure, while FIG. 1b shows the assembly 100 after installation. In the depicted embodiment, the seal 110 comprises a solid material layer 150, a two-sided adhesive laminate 180 and a one-sided adhesive laminate 190. The diffusion channel 120 comprises a first breather hole 170 and a second breather hole 125. The adsorbent breather filter 130 comprises a mounting adhesive 190, an adsorbent media 133, and a membrane 132. Additionally there may be an optional release liner 140 disposed along a portion of the mounting adhesive 190. The release liner 140 covers adhesive laminate 190, which when exposed is used to adhere the assembly 100 to a substrate, such as the top of a housing 195. Thus, the assembly 100 is configured to be received by a housing 195, such as for a hard disk drive (HDD). Typically the assembly 100 will be positioned on the exterior of the housing 195.

These adhesives 134, 180, 190 can be disposed on the appropriate layer by, for example, coating, painting, spraying, dipping, or otherwise applying the adhesive to the layer. In some embodiments, adhesive may be pre-applied on a commercially available film or adhesive carrier. The adhesive carrier is often a polymer film, such as, for example, a polyethylene, polypropylene, polyester, polycarbonate, polyurethane, or polyvinyl chloride film. The mounting adhesive 190 is generally an adhesive carrier with adhesive disposed thereon.

The adhesives 134, 180, and 190 can include permanent, semi-permanent, or temporary adhesives. The adhesive can be permeable to the fluid to be filtered or the adhesive can be non-permeable. Examples of suitable adhesives include epoxies, resins, pressure-sensitive adhesives, hot-melt adhesives, solvent-based adhesive, emulsion-based adhesives, and contact adhesives. One example of a suitable commercial adhesive is 3M 9461P adhesive from 3M Co. (St. Paul, Minn.). In some embodiments, other lamination techniques, such as heat lamination or sonic welding, may be used instead of one of more of the lamination adhesives 134, 180 and 190.

In many embodiments, the adhesives 134, 180, and 190 include only low out-gassing adhesives. Out-gassing includes the release and/or production of gaseous or other contaminants by the adhesive. Out-gassing by an adhesive or other component of the filter can produce additional contaminants that are often introduced into the fluid and removed by the adsorbent breather filter 130. Contamination of the fluid by adhesive out-gassing can also be decreased by reducing, and, preferably, minimizing, the exposure of the fluid flowing through the adsorbent breather filter 130 to the adhesives 134, 180, and 190. Often, adhesives are chosen which meet ASTM E-595-84 specifications with 1% or less total mass loss and 0.1% or less collected volatile condensable material. This, however, is not necessary to all implementations of the invention.

Typically, the adhesives 134, 180, and 190 in the assembly 100 have individual thicknesses that range from 10 μm to 150 μm, although thicker or thinner adhesives may be used. Often, the adhesives 134, 180, and 190 of the filter 100 have a thickness that ranges from 15 μm to 50 μm.

The optional release liner 140 is used to protect the mounting adhesive 140 prior to installation. Typically, the release liner 140 is formed of a material that can be separated from the mounting adhesive 190 without removing a substantial portion, and, preferably, without removing any, of the mounting adhesive 190 from the assembly 100. The mounting adhesive 190 may be deposited across the surface area of the bottom of the seal 110, or a portion of the surface area of the seal. The mounting adhesive 190 may be a continuous deposit across the surface area of the bottom of the seal 110 or the mounting adhesive 190 may be deposited in one or more discrete sections across the surface area of the bottom of the seal 110.

The solid material layer 150, two-sided adhesive laminate 180 and one-sided adhesive laminate 190 may be formed using a polymer and/or metallic film, for example. These films are often nonporous and have a low permeability to the fluid to be filtered, particularly, at the fluid pressures expected for operation of the filter 100. Films with higher permeability can, however, be used. The solid material layer 150, and two-sided adhesive laminate 180 need not comprise the same or similar materials.

Examples of suitable polymer films for use in the solid material layer 150, two-sided adhesive laminate 180, and one-sided adhesive laminate 190 include polyester (e.g., Mylar™), polyethylene, polypropylene, nylon, polycarbonate, polyvinyl chloride, and polyvinyl acetate films. Preferably, the polymer films have relatively low or no out-gassing. Suitable metallic films for use in the solid material layer 150, two-sided adhesive laminate 180, and one-sided adhesive laminate 190 include films formed using metals, such as, for example, copper and aluminum, and alloys, such as, for example, stainless steel. Preferred metal films do not significantly corrode or form reaction products (e.g., rust) that can be dislodged from the film under the expected operating conditions of the filter. In some embodiments, the metallic film may be deposited or otherwise formed on a base material, such as, for example, a polymer film.

The seal 110 generally defines the diffusion channel 120 having a first breather hole 170, and a second breather hole 125. The adsorbent breather layer 130 defines a breather hole extension 160 that is part of the diffusion channel 120. In this particular embodiment, the solid material layer 150 defines the first breather hole 170, the two-sided adhesive laminate 180 defines the diffusion channel 120, the one-sided adhesive laminate defines the second breather hole 125, and the mounting adhesive 190 defines the breather hole extension 160. The seal 110 prevents or restricts the flow of fluid and directs the flow of fluid along the diffusion channel 120. The portions of the seal 110 that forms a boundary surface for the diffusion channel 120 is typically substantially adhesive-free, resulting in a channel 120 that is substantially adhesive-free except for exposed edges of the mounting adhesive 190 and lamination adhesives 180, 190. This reduces out-gassing and can prevent occlusion of the diffusion channel 120. It will be understood that stray amounts of adhesive may be found in the diffusion channel 120, but overall the channel 120 is substantially adhesive-free.

The diffusion channel 120 can be formed, for example, by removing a portion of the two-sided adhesive laminate 180. In some embodiments the mounting adhesive 190 may be selectively applied to avoid the diffusion channel 120 location. The removed portion of these layers can be, for example, die-cut or otherwise removed using, for example, a stamping apparatus or a rotary press. The diffusion channel 120 may be formed as a straight or curved path. Alternatively, the diffusion channel 120 may be formed to have a more complex path, such as a winding path or a spiral path. The diffusion channel 120 may, in some embodiments, have two or more branches.

The diffusion channel 120 has a thickness that typically corresponds to the thickness of the two-sided adhesive laminate 180. The width of the diffusion channel 120 can vary over a wide range. The width of the diffusion channel 120 ranges from, for example, 1 mm to 10 mm, although wider or narrower diffusion channels 120 may be used. In some embodiments, the width of the diffusion channel 120 ranges from 1.5 to 5 mm. The width and thickness of the diffusion channel 120 may be chosen to balance the pressure drop of the assembly 100 between the diffusion channel 120 and the filter media 133, although this is not necessary.

The adsorbent breather filter portion 130 of the assembly 100 comprises an adhesive layer 190, an adsorbent media 133 and a membrane 132. The filter portion 130 fits within depression 126 in the electronic enclosure 195, and over port 127. The installed assembly 100 is substantially flush with the top surface 195a of the enclosure 195 in FIG. 1b, while the seal portion adheres at surface 195b of the inclosure within the depression 126. However, in the depicted embodiment, a space remains between surface 195c and membrane 132.

The adsorbent breather filter 130 may include a variety of materials. The adsorbent breather filter portion 130 may include other filtering elements. The adsorbent breather filter portion 130 may also include one or more support layers, such as woven or non-woven support scrims, and/or one or more porous films for containing material (e.g., particles, gels, or the like) used in the adsorbent media 133.

The membrane 132 enclosing the adsorbent media 133 may comprise a variety of porous and microporous membranes. The size of the pores in the membranes and the thickness of the membranes often determine, at least in part, the size of particles allowed through the membrane and/or filter. Often the porous or microporous membranes are formed from polymers. Examples of suitable porous or microporous membranes include porous or microporous polyethylene, polypropylene, nylon, polycarbonate, polyester, polyvinyl chloride, polytetrafluoroethylene (PTFE), and other polymeric membranes. One particularly suitable membrane is formed using expanded PTFE, which has nodes and fibrils providing a porous layer that allows passage of fluids while retaining particulate contaminants.

The adsorbent media 133 includes materials that adsorb and/or absorb contaminants by process, such as, for example, physisorption and/or chemisorption. The adsorbent media 133 may include a single type of material or a combination of materials. The adsorbent media 133 may remove a single contaminant or a number of contaminants. Examples of contaminants that may be removed include, for example, water, water vapor, chlorine, hydrogen sulfide, HCl, nitrogen dioxide, acid gases, and hydrocarbon compounds.

Examples of suitable adsorbent materials include silica gel, molecular sieves, desiccating materials, carbon particles, activated carbon, K₂ CO₃, and Na₂ CO₃.

The adsorbent media 133 may be in the form of, for example, particles, gels, sheets, webs, tablets, molded articles, or liquids, that are, preferably, held in place within the adsorbent breather filter portion 130. The adsorbent breather filter portion 130 of assembly 100 may contain a porous film around the adsorbent media 133 to retain this material within the filter. Such porous films may include, for example, polyethylene, polypropylene, nylon, polycarbonate, polyester, polyvinyl chloride, polytetrafluoroethylene (PTFE), and other polymeric films. Alternatively, the other layers in the adsorbent breather filter 130 or assembly 100 may act to retain the adsorbent filter material or the adsorbent filter material may be disposed on or within a polymer film.

The adsorbent breather filter 130 may also include one or more support layers, such as a support scrim, to support the porous or microporous membranes or to support the adsorbent media 133. Examples of such support layers include woven and non-woven films made from, for example, stretched or sintered plastics, such as polyesters, polypropylene, polyethylene, and polyamides (e.g., nylon). In some embodiments, the support layer may be porous and permit substantial cross-flow of fluid across the support layer and into other portions of the adsorbent breather filter portion 130.

One exemplary filter media 133 includes an expanded polytetrafluoroethylene membrane, a porous, polymeric support scrim, and carbon adsorbent material. The expanded polytetrafluoroethylene membrane is coupled to the mounting adhesive 190. Other configurations of filter media 133 can be formed using other combinations of layers.

The assembly 100 is configured to be received by a housing 195 of an enclosure where the filtration of incoming air is desired. The housing 195 is configured to receive the assembly 100 along the outside surface. The housing 195 may be for an HDD for example, although other types of housing can benefit from this technology.

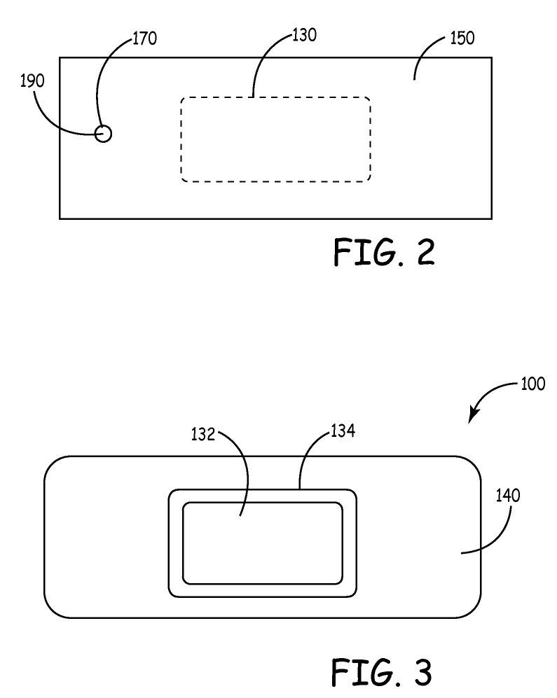

FIG. 2 is a top view of the embodiment depicted in FIG. 1. The solid material layer 150 is visible from this perspective, which also reveals the first breather hole 170. The first breather hole 170 may expose the surface of the one-sided adhesive laminate 190. The adsorbent breather filter 130 is not visible from this perspective, but an outline 130 of the general location is provided. While in this embodiment the first breather hole 170 has a circular opening, any shape may generally be used so long as air passage through the diffusion channel (not here pictured) is enabled.

FIG. 3 is a bottom view of the embodiment depicted in FIG. 1. The membrane 132 of the adsorbent breather filter 130 is visible from this view of the assembly 100. Also visible is the removable liner 140 disposed across the mounting adhesive 190. A portion of the mounting adhesive 190 may not be secured with removable liner if the mounting adhesive carrier 190 does not have adhesive disposed thereon. While the shape of the assembly 100 appears to be substantially rectangular in the figures, any shape may be applied that allows the functionality as described herein.

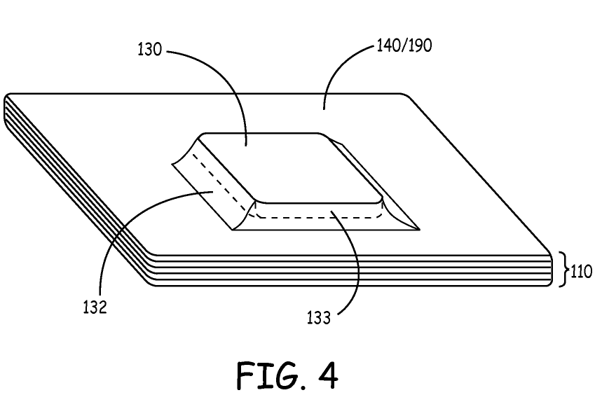

FIG. 4 is a bottom perspective view of one embodiment of the technology depicted in FIG. 1. The membrane 132 of the adsorbent breather filter 130 is visible from this view of the assembly 100. Also visible is the removable liner 140 disposed across the mounting adhesive 190. Represented by dotted lines is the adsorbent media 133, contained within the assembly.

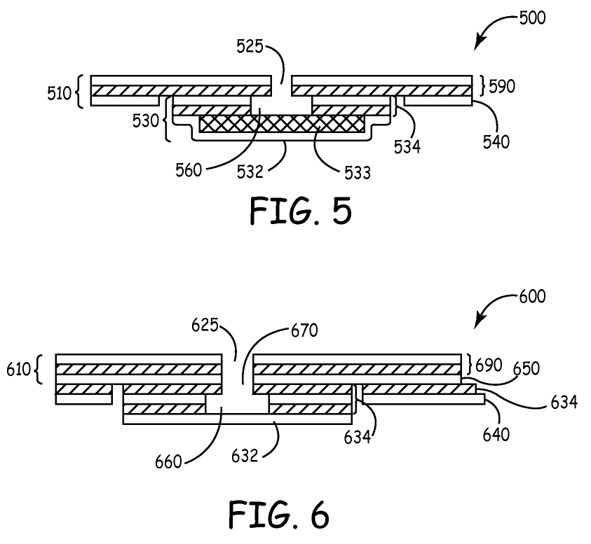

FIG. 5 is a cross sectional view of a further embodiment of the technology disclosed herein. An assembly 500 broadly comprises a seal portion 510 defining a breather hole 525, and an adsorbent breather filter portion 530. The seal 510 comprises a one-sided adhesive laminate 590 that defines a first breather hole 525. An optional removable liner 540 is disposed on the one-sided adhesive laminate 590. The adsorbent breather filter 530 defines a breather hole 560 and comprises a mounting adhesive 534, adsorbent media 533, and a membrane 532. The assembly 100 is configured to be received by housing. The assembly 500 is similar to the assembly 100 shown in FIG. 1, but assembly 500 does not contain a diffusion channel.

FIG. 6 is a cross sectional view of one embodiment of the technology disclosed herein. An assembly 600 broadly comprises a seal 610 defining a breather hole 625, and an adsorbent breather filter 630. The seal 610 comprises a one-sided adhesive laminate 690 that defines a first breather hole 625. A solid material layer 650 defines a second breather hole 670. A mounting adhesive 634 is disposed on the solid material layer 650, with an optional removable liner 640 disposed thereon. The adsorbent breather filter 630 defines an extension breather hole 660 and comprises a mounting adhesive 634, and a membrane 632. The assembly 100 is configured to be received by the housing. The mounting adhesive 634 may be a two-sided adhesive laminate, for example, or an adhesive layer, in another example, as discussed in FIG. 1, above. The assembly 600 is similar to the assembly 100 shown in FIG. 1, but assembly 600 does not contain a diffusion channel nor does it include adsorbent media.

The contaminant control media is typically provided for the removal of chemical contaminants. The contaminant control media can remove contaminants from the air entering the enclosure atmosphere or already present within the enclosure atmosphere by adsorption, neutralization, or immobilization. As used throughout this application, the terms “adsorb,” “adsorption,” “adsorbent” and the like, are intended to also include the mechanism of absorption. Typically, the contaminant control media is selected to be stable and adsorb or neutralize contaminants within normal disk drive operating temperatures, for example, within a range of about −40° C. to 100° C.

The contaminant control media adsorbs or neutralizes one or more types of contaminants, including, for example, water, water vapor, acid gas, and volatile organic compounds. The contaminant control media can include adsorbent material (physisorbent or chemisorbent material), such as, for example, a desiccant (i.e., a material that adsorbs or absorbs water or water vapor) or a material that adsorbs or absorbs volatile organic compounds, acid gas, or both. Suitable adsorbent materials include, for example, activated carbon, activated alumina, molecular sieves, silica gels, potassium permanganate, calcium carbonate, potassium carbonate, sodium carbonate, calcium sulfate, or mixtures thereof. Carbon is suitable for most implementations, and carbon suitable for use with the present invention is disclosed in U.S. Pat. No. 6,077,335, incorporated herein by reference in its entirety.

Additionally, contaminant control media can include neutralization material. Neutralization material can include acid or base impregnated substances that can effectively neutralize the gaseous contaminants found within the housing or electronic enclosure. Neutralization material can also include enzyme or catalyst impregnated substances that increase the rate of degradation of the gaseous contaminants found with the housing or electronic enclosure.

Although contaminant control media can be manufactured from a single substance, mixtures of materials are also useful, for example, silica gel can be blended with carbon particles. In some embodiments, the contaminant control media includes layers or combinations of materials, so that different contaminants are selectively removed as they pass through or by the different materials.

It will be appreciated that, contaminant control media can undertake many forms including powdered (passes through 100 mesh), granular (passes through 28 to 200 mesh), beads, slurry, paste and any combination thereof.

Filter media of the present invention may contain one or more particulate filter layers to prevent particulate contaminants from entering the electronic enclosure from the filter assembly. Such particulate contaminants may originate outside of the electronic enclosure or may be shed from the contaminant control media. Filters of the present invention may also include particulate filter layers to prevent particulate contaminants from entering the filter assembly from outside of the electronic enclosure. They may be disposed on the outside of the filter assembly or disposed inside of the filter assembly.

The filter media may comprise a variety of porous or microporous membranes. The size of the pores in the membranes and the thickness of the membranes often determine, at least in part, the size of particles allowed through the membrane and filter.

Often the porous or microporous membranes are formed from polymers. Examples of suitable porous or microporous membranes include porous or microporous polyethylene, polypropylene, nylon, polycarbonate, polyester, polyvinyl chloride, polytetrafluoroethylene (PTFE), and other polymeric membranes. An especially suitable filtering layer is expanded polytetrafluoroethylene (ePTFE) because of its good filtration performance, conformability to cover adsorbent layers, and cleanliness. A preferred ePTFE membrane has a filtration efficiency of 99.99% at 0.1 micrometer diameter sized particles with a resistance to airflow of approximately 20 mm water column at an airflow of 10.5 feet per minute face velocity. ePTFE is commercially available under the registered trademark GORE-TEX by W. L. Gore & Associates, Inc.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

It will be appreciated that, although the implementation of the invention described above is directed to a hard drive enclosure, the present device may be used with other electronic enclosures, and is not limited to hard drive enclosures. In addition, while the present invention has been described with reference to several particular implementations, those skilled in the art will recognize that many changes may be made hereto without departing from the spirit and scope of the present invention.

We claim:

1. A filter comprising:
a seal configured to be placed over an opening in an electronic enclosure, said opening located within a depression in the surface of the electronic enclosure, wherein the perimeter of the seal is configured to be adhesively secured along its perimeter to the surface of the electronic enclosure;
a filter element integral to the seal, the filter element configured to be placed within the depression in the surface of the electronic enclosure;
a channel providing fluid communication through the seal, said channel further providing fluid communication with the adsorbent-containing filter element.

2. The filter of claim 1, wherein the filter is configured and arranged for filtering air.

3. The filter of claim 1, wherein the filter element includes media comprising a microporous membrane.

4. The filter of claim 3, wherein the microporous membrane comprises a polytetrafluoroethylene membrane.

5. The filter of claim 1, wherein the filter element comprises carbon filter material.

6. The filter of claim 1, wherein the filter element comprises a porous support layer.

7. The filter of claim 1, wherein the channel is configured and arranged to provide for flow of at least a portion of a fluid along the channel, into the filter media, and through the passageway.

8. The filter of claim 3, wherein the filter is configured and arranged to provide for flow of at least a portion of a fluid along the channel and through the filter media, said boundary layer being substantially impermeable to air flow.

9. The filter of claim 1, further comprising a boundary layer on the seal.

10. The filter of claim 9, wherein the boundary layer comprises a polymer or metal film.

11. A filter for application over a breather hole in an electronic enclosure the, filter comprising:
a seal configured to be placed over a breather opening in an electronic enclosure, said opening located within a depression in the surface of the electronic enclosure, the seal comprising an adhesive border portion configured to be secured the electronic enclosure, a substantially air-impermeable layer, and diffusion channel in fluid communication through the air-impermeable layer; and
an absorbent-containing filter element, the filter element configured to be placed at least partially within the depression in the surface of the electronic enclosure;
wherein air is allowed to pass through the diffusion channel, through the adsorbent-containing filter element, and into the electronic enclosure.

12. The filter of claim 11, wherein the filter is configured and arranged for filtering air.

13. The filter of claim 11, wherein the filter comprises a microporous membrane.

14. The filter of claim 13, wherein the microporous membrane comprises a polytetrafluoroethylene membrane.

15. The filter of claim 11, wherein the channel is configured and arranged to provide for flow of at least a portion of a fluid along the channel, into the filter media, and through the passageway.

16. A filter for application over a breather hole in an electronic enclosure, the filter comprising:
a seal configured to be placed over a breather opening in an electronic enclosure, said opening located within a depression in the surface of the electronic enclosure, the seal comprising:
an air-impermeable layer,
a diffusion channel travelling through the seal,
an adsorbent within a filter element in communication with the diffusion channel, and
a filter media in communication with the adsorbent and diffusion channel;
wherein air is allowed to pass through the diffusion channel and into the adsorbent-containing filter element.

17. The filter of claim 16, wherein the filter is configured and arranged for filtering air.

18. The filter of claim 16, wherein the filter media comprises a microporous membrane.

19. The filter of claim 18, wherein the microporous membrane comprises a polytetrafluoroethylene membrane.

20. The filter of claim 16, wherein a channel layer film in the seal has a passageway spaced apart from the channel and the filter is configured and arranged to provide for flow of at least a portion of a fluid along the diffusion channel, into the filter media, and through the passageway.
